(19) United States
(12) Patent Application Publication
(10) Pub. No.: US 2015/0148281 A1
(43) Pub. Date: May 28, 2015

(54) ADHESIVE DETERGENT AND/OR PERFUMING COMPOSITION

(71) Applicant: BOLTON MANITOBA S.p.A., Milano (IT)

(72) Inventors: Federico DE PELLEGRINI, Monza (IT); Gianni ALDERUCCIO, Bovisio Masciago (IT); Luciano NOVITÁ, Segrate (IT); Valentina VILLA, Calusco D'Adda (IT)

(21) Appl. No.: 14/552,670

(22) Filed: Nov. 25, 2014

(30) Foreign Application Priority Data
Nov. 26, 2013 (IT) MI2013A001972

(51) Int. Cl. C11B 9/00; C11D 3/34; C11D 3/08; C11D 17/00; C11D 3/50

(52) U.S. Cl. CPC C11B 9/00; C11D 17/003; C11D 3/50; C11D 3/08; C11D 3/3409
USPC 510/403; 510/404; 512/4; 512/2

(57) ABSTRACT

An adhesive detergent and/or perfuming composition, in the form of gel or a paste, directly applicable onto the surface of interest, adhering thereto without the aid of a support and/or container, and from which, if subjected to the action of water, is removed only after a great number of flushing operations, comprising
i) an adhesion promoter composed of one or more salts of alkyl ether sulphate, preferably lauryl ether sulphate salts;
ii) silica;
iii) a perfuming agent;
iv) water.

The present invention refers to an adhesive detergent and/or perfuming composition.

The present invention falls within the technical field of detergent and/or perfuming products in the solid, gel or pasty form, to be applied onto the internal wall of sanitary objects such as toilet bowls, bidet, washbasins, pissoirs.

In particular the present invention falls in the technical field of detergent and/or perfuming products, in the solid, gel or pasty form, directly applied onto the surface of interest, adhering thereto thanks to their intrinsic features, without the aid of means and/or containers, i.e., of external devices.

Adhesive detergent and/or perfuming compositions are known and subject-matter of wide marketing, capable to adhere to the walls of toilet bowls without the aid of any external device, precisely without need of being inserted into the usual plastic cages.

The existing formulations according to the state of the art are mainly based on the use of a group of components, the alcohol ethoxylates, known to have adhesive properties.

More specifically, the alcohol ethoxylates are non-ionic surfactants which, for being provided also of adhesive properties, shall be characterized by a long hydrocarbon chain and by a high ethoxylation degree.

Examples of adhesive compositions which can be directly applied onto the sanitary objects without the aid of any support and/or container, based on alcohol ethoxylates, are disclosed in EP1086199 and EP1325103.

As previously observed, in order to have a sufficient adhesiveness, the alcohol ethoxylates must be high ethoxylation alcohols, present in high concentration, as required also for any non-ionic surfactant which acts as adhesion promoter. These raw materials usually present the feature of being solid at room temperature and the adhesive composition so formulated is characterized by a poor foaminess.

Indeed it should be kept in mind that a much important feature of adhesive detergent and/or perfuming compositions is that of having a good foaming capacity which, when in use, ensures a good cleaning effect and a good foam profile at each water flushing operation. In general, the adhesive compositions in gel according to the state of the art are characterized by quite a low foaminess, thus resulting in the need of including appropriate surfactants/additives, to allow the product to provide a sufficient level of foam in use, both to exert the detergent action and to satisfy the user with a sufficient foam profile.

The challenge for the skilled person in the art is right that of identifying a particular adhesive detergent and/or perfuming composition allowing at the same time to combine the use of high foaming surfactants with sufficient adhesive properties of the composition. Moreover, such a specific and particular adhesive composition allows to keep the composition itself adhered to the wall of the toilet bowl for a useful lifespan, ensuring also a sufficiently solid structure for the entire lifetime of the product, which does not collapse by effect of the first flushing operations.

The use of anionic surfactants, which provide a high level of foam in use, gives in fact rise to a strong instability of the structure of the adhesive composition, which leads to collapsing of the gel in a very short time (often instantaneous). The cationic surfactants which, with respect to the anionic surfactants, generally allow to keep the structure of the adhesive composition, in several cases can instead nullify the foam profile, making their use particularly difficult.

In particular, adhesive products for toilet bowls based on sodium alkyl ether sulphate, the foaming surfactant of choice, used in all those applications requiring very high foaming performance (for example in dish soaps, bubble baths, etc.)are unknown. That absence of prior art is not surprising: adhesive products for toilet bowls based on significant amounts of this surfactant lead to the achievement of adhesive compositions with a very unstable structure, which tends to collapse in a very short time. The known art comprises products containing other anionic surfactants, such as for example LAS, conventionally used in toilet blocks. Such surfactants are less foaming than LES and are very sensitive to water hardness. They tend therefore to produce less foam, said foam tending moreover to collapse immediately in hard water.

The Applicant has now surprisingly found an adhesive detergent and/or perfuming composition, in gel or in paste form, which overcomes the drawbacks of the state of the art as previously reported.

A main purpose of the present invention is therefore that of finding an adhesive detergent and/or perfuming composition, in gel or in pasty form, which can be directly applied onto the surface of interest, adheres thereto without the aid of means and/or containers, guarantees an optimal adhesion to the surface, an adequate duration in use, and at the same time shows excellent foaming performance

Object of the present invention is therefore an adhesive detergent and/or perfuming composition, in the form of gel or paste, directly applicable onto the surface of interest, adhering thereto without the aid of supports and/or containers, and from which, if subjected to the action of water, is removed only after a great number of rinsing operations, said composition being characterized in that it comprises

i) an adhesion promoter consisting of one or more salts of alkyl ether sulphates, preferably lauryl ether sulphate salts;

ii) silica;

iii) a perfuming agent;

iv) water.

In particular and very surprisingly, the adhesive composition, in gel or pasty form, according to the present invention, which is based on the very presence of an anionic surfactant ensuring the best foaminess, such as one or more salts of alkyl ether sulphates and preferably lauryl ether sulphate salts, in combination with silica, presents an optimal combination of adhesiveness and foaminess features fully unexpected with respect to what is known to the state of the art.

Such a composition is based, in its preferred embodiments, on a single class of surfactants extremely foaming (alkyl ether sulphate salts), whereas LAS, the most commonly used surfactant in toilet blocks, is basically absent (alkyl benzene sulfonate or dodecyl benzene sulfonic acid). Such a surfactant ensures an acceptable foaminess, but it is very sensitive to water hardness and so it is not one of the base components of the composition according to the present invention; in particular, if provided as co-formulant, LAS is however in low amount, at most up to 5-7% by weight with respect to the total weight of the adhesive composition.

The adhesive composition according to the present invention derives its excellent properties of adhesiveness and stability of the solid structure (in gel or paste) in a particular and surprising manner right from the combination between LES and silica. Said combination, optionally in the presence of appropriate co-formulants, allows indeed to achieve an optimal balance of foaminess, adhesiveness and stability of the structure during use.

A further advantage of the adhesive composition according to the present invention is that of having a very high melting point, resulting in a substantially irreversible gel which, even at high temperatures, does not drip and does not move.

The adhesive composition, in gel, according to the present invention, presents a peculiar rheological structure which cannot be defined through a simple viscosity measurement. The result of an Amplitude Sweep analysis carried out with a plate-plate system rheometer in an oscillating mode, shows how the gel is characterized by a structure which is mostly elastic.

This feature is reflected also in the absolute values of G′ and G″, wherein G′ (indicating the elastic component of the product) is always prevailing on G″ (indicating the viscous component). In particular it is observed that the values of G′ vary from a minimum of 10000 Pa to a maximum of 200000 Pa, whereas G″ vary between 1500 Pa and 23000 Pa.

The viscosity and the rheological structure of the adhesive composition, in form of a gel or a paste, according to the present invention are however such as to avoid sliding and allow adhesion of the composition to a sloping or vertical surface.

No viscosity value can be defined for the adhesive composition according to the present invention in pasty form, being in fact such form a solid.

The adhesion promoter in the adhesive composition according to the present invention consists of one or more salts of alkyl ether sulphates, wherein the cation is a cation of organic or inorganic origin and the anion has formula

CH₃(CH₂)ₘCH₂(OCH₂CH₂)nOSO₃⁻

with m varying from 6 to 22, preferably from 8 to 16 and still more preferably equal to 10 and n varying from 1 to 5, preferably equal to 1 or 2.

When the cation of the alkyl ether sulphate salt is a cation of inorganic origin, said cation is preferably selected from sodium, potassium, magnesium, ammonium, lithium and is preferably sodium or magnesium. Such species can also be created in situ for example by simultaneous addition of sodium alkyl ethoxy sulphate and magnesium sulphate in the adhesive composition.

When the cation of the alkyl ether sulphate salt is a cation of organic origin, said cation is preferably RR₁R₂NH⁺, wherein R, R₁ and R₂, independently from each other, are preferably selected from hydrogen, ethyl, propyl, isopropyl, butyl, isobutyl, hydroxyethyl, hydroxypropyl, hydroxybutyl, hydroxyisopropyl provided that at least one of the groups R, R₁ and R₂ is different from a hydrogen atom. Still more preferably one of the substituents R, R₁ and R₂ is equal to hydroxyisopropyl and the remaining two are a hydrogen atom.

The adhesive composition in form of a gel according to the present invention comprises the adhesion promoter in amount varying from 20 to 60% by weight, preferably varying from 30 to 50% and still more preferably is equal to 45% by weight, with respect to the total weight of the adhesive composition.

The adhesive composition in form of a paste according to the present invention comprises the adhesion promoter in amount varying from 35 to 70% by weight, preferably varying from 35 to 55% and still more preferably is equal to 45% by weight, with respect to the total weight of the adhesive composition.

The adhesive composition according to the present invention comprises silica as component ii).

In general, the silica useful for the purpose of the present invention can be amorphous or crystalline, it is preferably synthetic, amorphous and precipitated. The silica in the adhesive composition according to the present invention presents an average particle size lower than 500 micron, preferably lower than 100 micron and still more preferably has a particle size comprised between 8 and 13 micron, with an average value equal to 10 micron.

The amount of silica in the adhesive composition in form of a gel according to the present invention varies from 0,1 to 20% by weight, preferably varying from 0,5 to 10% by weight and still more preferably it is equal to 8% by weight, with respect to the total weight of the adhesive composition.

The amount of silica in the adhesive composition in form of a paste according to the present invention varies from 15 to 40% by weight, preferably varying from 20 to 35% by weight and still more preferably it is equal to 25% by weight, with respect to the total weight of the adhesive composition.

The adhesive composition, in form of a gel or a paste, according to the present invention comprises a perfuming agent as component iii).

The perfuming agent is present in amount varying from 0.1 to 7% by weight, preferably from 2 to 4% by weight and still more preferably is equal to 3% by weight, with respect to the total weight of the adhesive composition.

The adhesive composition in form of a gel according to the present invention provides the presence of water, in amount varying from 20 to 70% by weight, preferably from 35 to 60% by weight, with respect to the total weight of the adhesive composition. The adhesive composition according to the present invention provides an adhesion promoter/water weight ratio ranging from 25:75 to 60:40, preferably equal to 50.56:49.44.

In particular, the adhesive composition, in gel, according to the present invention, which provides such a promoting agent/water ratio, presents an optimal combination of adhesiveness and foaminess features.

The adhesive composition in form of a paste according to the present invention provides the presence of water, in amount varying from 10 to 30% by weight, preferably from 15 to 25% by weight, and still more preferably is equal to 23% by weight, with respect to the total weight of the adhesive composition. The adhesive composition according to the present invention provides an adhesion promoter/silica weight ratio ranging from 75:25 to 56:44, preferably equal to 66:34. In particular the adhesive composition, in paste, according to the present invention, which provides such a promoting agent/silica ratio, presents an optimal combination of adhesiveness, foaminess and extrudability features of the so obtained paste.

Indeed, ratios providing a greater amount of adhesion promoter lead to obtain soft pastes, not extrudable, devoid of the required texture, whereas greater amounts of silica do not allow to achieve products characterized by sufficient adhesiveness.

Also in the case of the adhesive composition in paste, the problem of formulating an adhesive compound based on LES is solved and the resulting products are significantly more foaming than those of the prior art. The adhesive composition in form of a gel or a paste according to the present invention can also comprise, as minority components, colorants with the objective to confer a more pleasant appearance to the adhesive composition, and/or preservatives and/or disinfecting agents, selected from those commonly known to the skilled person in the art. The adhesive composition in form of a gel or a paste according to the present invention can also comprise agents having a biological action and/or of biological origin (for example bacteria, spores, enzymes, yeasts, mildews) which supplement the cleaning action of surfactants present in the adhesive composition or they generate other advantages, for example deodorization and biological control.

As an example, such minority components can be colorants in amount lower than 1% by weight with respect to the total weight of the adhesive composition, dichloroisocyanurate (merely for the form in paste) in amount ranging from 0 to 8% by weight with respect to the total weight of the adhesive composition, sodium percarbonate (only for the form in paste) in amount ranging from 0 to 5% by weight with respect to the total weight of the adhesive composition, spores/enzymes in amount ranging from 0 to 3% by weight with respect to the total weight of the adhesive composition, bentonites in amount ranging from 0 to 5% by weight with respect to the total weight of the adhesive composition.

The adhesive composition in form of a paste according to the present invention may also comprise an inert agent or inorganic filler selected among sulphates, chlorides or carbonates of sodium, magnesium, potassium, ammonium or calcium, soluble or insoluble, in an amount ranging of from 0.1 to 30% by weight, preferably of from 0.1 to 10% by weight and still more preferably equal to 5% by weight, with respect to the total weight of the adhesive composition.

In the case of magnesium salts, magnesium sulphate can be used for forming magnesium LES in situ.

The adhesive composition in form of a paste according to the present invention may also comprise a stabilizing agent in an amount ranging of from 0.1 to 10% by weight, preferably of from 0.1 to 5% by weight and still more preferably equal to 0.6% by weight, with respect to the total weight of the adhesive composition.

Said stabilizing agent can be selected among hydrolysed proteins, preferably hydrolysed wheat proteins (for example Cocodimonium Hydroxy propyl Hydrolysed Wheat Protein, Vegequat, Sinerga), urea, hydroxy-ethyl-urea and alkyl lactate, allowing to increase the stability of the paste over time, maintaining a constant hydration; the percentage of addition has to be therefore carefully considered because an excessive amount of stabilising agent can decrease the adhesion power of the composition.

The adhesive compositions in form of a gel according to the present invention may also include agents useful to improve its consumption in use. An example of such agent consists of hydrolysed proteins, for example hydrolysed wheat proteins (Cocodimonium Hydroxy propyl Hydrolysed Wheat Protein, Vegequat, Sinerga). The adhesive composition in gel according to the present invention preferably provides the following composition

i) sodium lauryl ether sulphate (SLES) or isopropanolammonium lauryl ether sulphate with n equal to 2;

ii) silica;

iii) a perfuming agent;

iv) water.

Still more preferably, the adhesive composition in gel according to the present invention is composed of 45% by weight of sodium and/or magnesium lauryl ether sulphate (SLES) or of isopropanolammonium lauryl ether sulphate, with n equal to 2, of 8% by weight of silica, of 3% by weight of perfume, and of 44% by weight of water. Such percentages are all weight/weight ratios with respect to the total weight of the adhesive composition.

The adhesive composition in paste according to the present invention preferably provides the following composition

i) sodium lauryl ether sulphate (SLES) or isopropanolammonium lauryl ether sulphate with n equal to 1;

ii) silica;

iii) a perfuming agent;

iv) water;

v) an inert agent or filler;

vi) a stabilizing agent.

Still more preferably, the adhesive composition in paste according to the present invention is composed of 45% by weight of sodium and/or magnesium lauryl ether sulphate (SLES) or of isopropanolammonium lauryl ether sulphate, with n equal to 1, of 25% by weight of silica, of 5% by weight of magnesium sulphate heptahydrate, of 3% by weight of perfume, of 0.6% by weight of hydrolysed wheat proteins and of 23% by weight of water.

A further object of the present invention is the use of said adhesive composition, in form of a gel or a paste, as detergent and/or perfuming agent, by direct application onto the surface of interest of sanitary objects, household appliances, etc.

A further object of the present invention is the process of application of said adhesive composition directly onto the surface of interest, adhering thereto without the aid of means and/or containers.

The process for obtaining an adhesive composition in the form of gel according to the present invention comprises the following phases:

in an emulsifier provided with a vacuum system, SLES along with perfume and possible colour mixture are loaded in condition of motionless paddles. The mixture is then subjected to medium stirring under vacuum, verifying then the complete dispersion of all the components. Silica is thus added under heavy stirring obtaining a hard and homogeneous compound to which the amount of water according to the recipe is finally added. The process is carried out cold and the maximum temperatures which can be achieved are 40/45° C., due only to mechanical friction of the stirrers.

The adhesive composition in paste can be advantageously achieved through a conventional process similar to those used for common toilet blocks, providing a mixing of the components followed by extrusion. Once extruded, the resulting product can be optionally moulded to generate adhesive objects for toilet bowls of increased aesthetic value.

More precisely, the process to obtain an adhesive composition in paste according to the present invention comprises the following steps: SLES is loaded in a suitable mixer and, under motionless stirrer, the amount of silica and magnesium sulphate is added. At the end of the additions, the mixture gets stirred for a proper time to obtain complete homogeneity. The minor components, previously pre-mixed, are then added. The premix is composed by perfume, dyes and a small quantity of SLES to emulsify the dyes. The pre-mixture is loaded into the mixer and it is left under stirring until homogeneity. Once this operation is completed, the preparation terminates by adding the stabilizing agent.

Once the mixing is completed, the resulting composition is extruded as commonly in use in the field.

The whole process (mixing and extrusion) occurs under cold conditions; indeed, the maximum temperatures reached during mixing, merely due to mechanical friction, are of 35/40° C. The head of the extruder is cooled to ensure the extrusion itself to be successful. Once extruded, the pasty product can be cut to generate some rectangular portions of product to adhere to the wall of the toilet bowl, or it can be moulded.

This last option results to be particularly advantageous as it allows to provide the product with a particularly pleasant aesthetic effect. It is possible to obtain an adhesive composition for toilet bowls in the form of flower, leaf, shell, etc. That result can be obtained using the same moulding technologies commonly used in the soap industry for example the press moulding (wherein an extruded mass is compressed in the desired form by means of a mould from a larger portion of paste) or box moulding (wherein a pre-weighed portion of paste is compressed in the desired form).

With respect to the processes of preparation of analogous products, the above mentioned processes present also the following advantage:

the heating of the composition is extremely limited; this avoids evaporation of volatile substances as the perfuming agents.

The adhesive composition in form of a gel or a paste according to the present invention can be applied in a form having a size of about 4×2×1 cm, which minimizes its visibility when applied on the surface of interest, as opposed to much larger and more visible products known in the state of the art.

The size of the adhesive composition applied to the surface according to the present invention depends mainly on the desired lifespan of the product in use. If, for sanitizing a domestic toilet bowl, an adhesive composition is subjected to flushing operations with a variable volume from 6 to 9 litres each, the adhesive composition according to the present invention, having a weight of about 10 grams, is completely washed-off only after about 90-130 rinsing operations, keeping in mind that the number of flushing operations necessary to the complete wash-off also depends on the geometry of the toilet-block and on the type of flow of the flushing water in the toilet bowl.

The adhesive composition in form of a gel or a paste according to the present invention, applied onto the wall of the toilet bowl, and subjected to a normal flushing cycle (about 12 flushing operations per day) presents therefore an average lifespan of about ten days.

In particular, in order to simplify the application of the adhesive composition in form of a gel to the sanitary object, the composition can be provided with a support, such as for example a thermoformed plastic support from which the adhesive composition can be easily extruded through thumb pressure.

Alternatively, the adhesive composition in form of a gel according to the present invention can be applied to the wall of interest by means of suitable applicators, such as for example dispensing cans, exploiting under pressure technologies, preferably of the Bag on Valve type. The Bag on Valve technology allows to keep propellant and product separate, and consists of an aerosol valve on which a bag is welded. Through the Bag on Valve system the compressed air or the liquefied gas in the aerosol can are contained outside the bag and act - expanding once the actuator of the valve is operated - as propellant on the product present inside, without coming into contact with the product.

Additional to the advantages as previously outlined, a key further advantage of the adhesive composition according to the present invention is represented by the fact that it is capable to achieve an optimal foam profile ensuring an effective cleaning.

Moreover, the particular combination of components constituting the adhesive composition according to the present invention, and in particular the selection of an alkyl ether sulphate salt, preferably a lauryl ether sulphate salt, as adhesion promoter, in the presence of silica, as well as the ratio between adhesion promoter and water and between promoter of adhesion and silica, allow to obtain an end-product which, surprisingly, is capable to preserve the adhesive properties for a long time, ensuring at the same time an excellent foaminess, and presenting an optimal rheology for the application of the product directly to the wall of the sanitary object.

The following examples are supplied with a mere illustrative purpose.

### EXAMPLES 1-3

Using the previously described preparation process for the adhesive compositions in the form of gel, three different adhesive compositions in gel have been prepared, according to the present invention, having the formulation reported in Table 1 below.

| Composition | Example 1 | Example 2 | Example 3 |
|---|---|---|---|
| Adhesion | Sodium ether sulphate 1 mole | Sodium ether sulphate 1 mole | Sodium ether sulphate 1 mole |
| Promoter | of alcohols C12-14 | of alcohols C12-14 | of alcohols C12-14 |
| | (Zetesol AN70 ex Zschimmer | (Zetesol AN70 ex Zschimmer | (Zetesol AN70 ex Zschimmer |
| | & Schwartz): | & Schwartz: | & Schwartz: |
| | 51.47% = 35% active matter | 66.18% = 45% active matter | 66.18% = 45% active matter |
| Solvent | Water | Water | Water |
| | 44.53% | 44% | 43.7% |
| Silica | Amorphous silica with | Amorphous silica with particle | Amorphous silica with particle |
| | particle size 10 micron | size 10 micron | size 10 micron |
| | (Tixosil 331 ex Rhodia) | (Tixosil 331 ex Rhodia) | (Tixosil 331 ex Rhodia) |
| | 1% | 8% | 8% |
| Perfume | Lemonaria 287495 ex | Lemonaria 287495 ex | Lemonaria 287495 ex |
| | Firmenich | Firmenich | Firmenich |
| | 3% | 3% | 4% |
| Stabilizing agent | | | Hydrolized wheat proteins |
| | | | (Vegequat ex Sinerga) |
| | | | 1% = 0.3% active matter |
| Appearance | Semi-transparent translucent | Semi-transparent translucent | Semi-transparent translucent |
| | Gel | Gel | Gel |
| Adhesiveness | Excellent up to end | Excellent up to end | Excellent up to end |
| | consumption | consumption | consumption |
| Foaminess | 3-4 cm | 3-4 cm | 3-4 cm |

The adhesive compositions in gel according to the formulations reported in Table 1 are completely translucent and firmly adhere, when applied onto the wall of the toilet bowl and subjected to a normal flushing cycle (about 12 rinsing operations per day). Moreover the look and the adhesiveness are not modified even in the absence of flushing operations exceeding 2 days.

The perfume used in the present examples is Lemonaria 287495 ex Firmenich, but can be replaced with any other perfume suitable for the purpose.

The level of foam produced by the adhesive composition according to example 2 has been assessed in comparison with a commercial sanitary agent in gel (according to EP1086199 and EP1325103) and a solid toilet-block of the conventional type, measuring the quantity expressed in cm of residual foam in the well of the toilet bowl after 1, 15 and 55 flushing operations, awaiting 30 seconds from the end of flushing for measuring, obtaining the results reported in the following table 2.

TABLE 2

| | | Standard | Block in | | Standard | Block in | | Standard | Block in |
|---|---|---|---|---|---|---|---|---|---|
| | | solid | gel | | solid | gel | | solid | gel |
| | Example 2 | block | cageless | Example 2 | block | cageless | Example 2 | block | cageless |
| Toilet Bowl Type | Adhesive | Block in a | Adhesive | Adhesive | Block in | Adhesive | Adhesive | Block in | Adhesive |
| | gel | cage | gel | gel | a cage | gel | gel | a cage | gel |
| | Foam N^{o} of flushing operations | | | Foam N^{o} of flushing operations | | | Foam N^{o} of flushing operations | | |
| | 1 | | | 15 | | | 55 | | |
| Sanremo | 3 | 1 | 1 | 4 | 3 | 1 | 4 | 3 | 1 |
| Tesi | 4 | 1 | 2 | 4 | 4 | 2 | 4 | 4 | 2 |
| Selnova | 2 | 1 | 1 | 2 | 2 | 1 | 3 | 2 | 2 |
| Allia | 2 | 1 | 2 | 3 | 3 | 1 | 3 | 3 | 1 |
| Conca | 4 | 1 | 2 | 4 | 2 | 1 | 4 | 2 | 1 |

### EXAMPLES 4-6

Using the previously described process of preparation, three different adhesive compositions in paste have been prepared, having the formulation reported in Table 3.

TABLE 3

| Composition | Example 4 | Example 5 | Example 6 |
|---|---|---|---|
| Adhesion | Sodium ether sulphate 1 mole | Sodium ether sulphate 1 mole | Sodium ether sulphate 1 mole |
| Promoter | of alcohols C12-14 | of alcohols C12-14 | of alcohols C12-14 |
| | (Zetesol AN70 ex Zschimmer | (Zetesol AN70 ex Zschimmer | (Zetesol AN70 ex Zschimmer |
| | & Schwartz): | & Schwartz: | & Schwartz: |
| | 66% = 45% active matter | 66% = 45% active matter | 66% = 45% active matter |
| Silica | Amorphous Silica with | Amorphous Silica with particle | Amorphous Silica with particle |
| | particle size 10 micron | size 10 micron | size 10 micron |
| | (Tixosil 43 ex Rhodia) | (Tixosil 43 ex Rhodia) | (Tixosil 43 ex Rhodia) |
| | 24% | 25% | 28% |
| Solvent | Water | Water | Water |
| | 23.245% | 21.8453% | 23.845% |
| Inert Agent | Magnesium Sulphate | Magnesium Sulphate | |
| | heptahydrate (Magnesium | heptahydrate (Magnesium | |
| | Sulphate heptahydrate ex | Sulphate heptahydrate ex | |
| | Chimitex ) | Chimitex ) | |
| | 4% | 5% | |
| Perfume | Lime Freshness TEU-G-4750 | Lime Freshness TEU-G-4750 | Lime Freshness TEU-G-4750 |
| | ex Takasago | ex Takasago | ex Takasago |
| | 3% | 3% | 3% |
| Stabilizing | Hydrolysed Proteins of Wheat | | Hydrolysed Proteins of Wheat |
| Agent | (Vegequat ex Sinerga) | | (Vegequat ex Sinerga) |
| | 0.6% | | 0.6% |
| Appearance | Elastic translucent paste | Elastic translucent paste | Elastic translucent paste |
| Adhesiveness | Excellent until the end of | Excellent until the end of | Excellent until the end of |
| | consumption | consumption | consumption |
| Foaminess | 4-5cm | 4-5cm | 5-6cm |
| Lifespan | 9 gg | 9 gg | 7 gg |

The perfume used in the present examples is Lime Freshness TEU-G-4750 ex Takasago, which can be however substituted with any other suitable for the purpose.

As derivable from the examples reported in table 3, lifespan and foam of the adhesive compositions in paste subject-matter of the test resulted excellent. In particular it is hereinafter reported in table 4 a comparison between the foaming performance of the adhesive composition according to example 4 and the results in terms of produced foam of adhesive solid blocks available on the market. In particular, levels of residual foam in the well of the toilet bowl after 1, 15 and 55 flushing operations have been compared, measured 30 seconds from the end of the flushing.

TABLE 4

| | | Adhesive solid | | |
|---|---|---|---|---|
| | Example 4 | block | Adhesive solid block | Adhesive Toilet block |
| Toilet bowl | Bolton | Unilever | Sc Johnson | Henkel |
| type | Manitoba | | | |
| | Adhesive | Self-adhesive | Self-adhesive | Self-adhesive |
| | translucent | opaque paste | opaque paste | double-extruded |
| | paste | | | opaque paste |
| Sanremo | 5 cm | 3 cm | 2 cm | 2 cm |

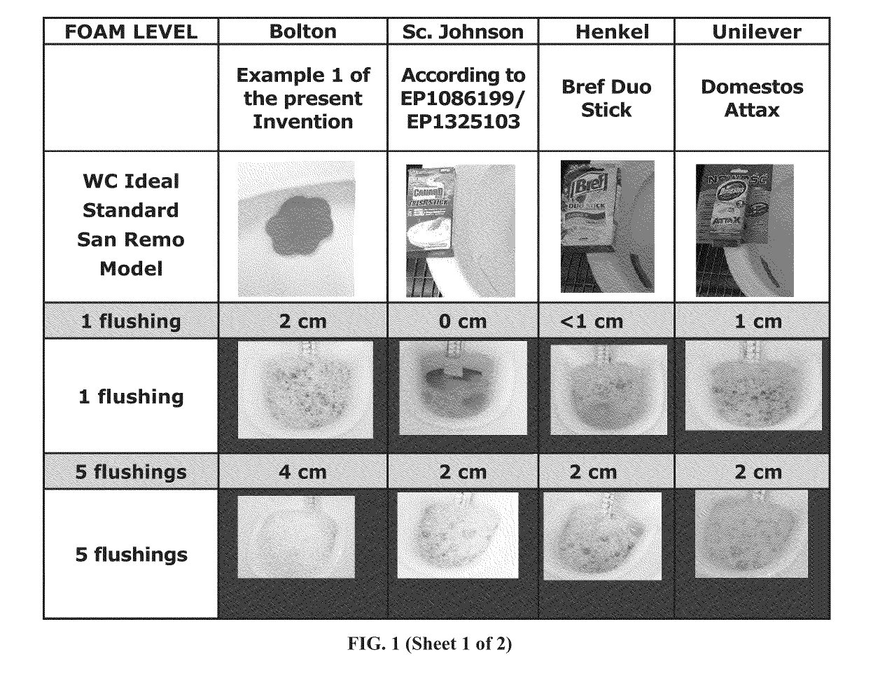

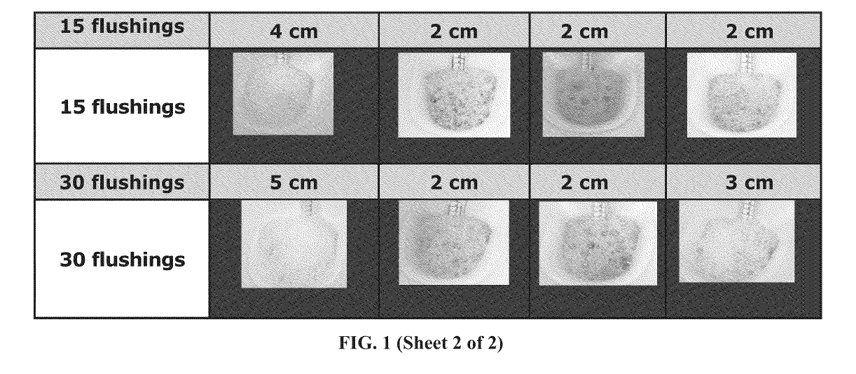

In the attached FIG. 1, the levels of foam reported in the previous table 4 have been photographed.

### EXAMPLES 7-10 (COMPARATIVE)

In the comparative examples 7-9, some existing products have been tested, with several adhesion promoters, to outline the differences, shown in the below table 5, in terms of adhesiveness and foaminess of the product. Comparative example 10 is a composition using LES as adhesion promoter but wherein silica is absent.

TABLE 5

| Composition | Example 1 | Example 7 | Example 8 | Example 9 | Example 10 |
|---|---|---|---|---|---|
| Adhesion Promoter | Sodium ether | Castor oil | Castor oil | Ethoxylated | Sodium ether |
| | sulphate 1 mole | ethoxylate | ethoxylate | tallow amine | sulphate 1 mole |
| | of alcohols | (Emuson | (Emuson | 35 moles | of alcohols |
| | C12-14 | COH-40 ex | COH-40 ex | (Diammin S35 | C12-14 |
| | (Zetesol AN70 | Lamberti) | Lamberti) | ex SASOL) | (Zetesol AN70 |
| | ex Zschimmer | 40% | 40% | 45.76% = 41% | ex Zschimmer |
| | & Schwartz): | | | active matter | & Schwartz): |
| | 51.47% = 35% | | | | 66.18% = 45% |
| | active matter | | | | active matter |
| Solvent | Water | Water | Water | Water | Water |
| | 44.53% | 48.80% | 44.80% | 46.64% | 52% |
| Thickener | — | Xanthan gum | Xanthan gum | Xanthan gum | — |
| | | (Kelzan ex | (Kelzan ex CP | (Kelzan ex CP | |
| | | CP Kelco) | Kelco) | Kelco) | |
| | | 0.2% | 0.2% | 0.4% | |
| Silica | Amorphous | — | — | — | — |
| | Silica with | | | | |
| | particle size 10 | | | | |
| | micron | | | | |
| | (Tixosil 331 ex | | | | |
| | Rhodia) | | | | |
| | 1% | | | | |
| Peg 6000 | — | — | — | 0.2% | — |
| Perfume | Lemonaria | Lemonaria | Lemonaria | Lemonaria | Lemonaria |
| | 287495 ex | 287495 ex | 287495 ex | 287495 ex | 287495 ex |
| | Firmenich | Firmenich | Firmenich | Firmenich | Firmenich |
| | 3% | 6% | 6% | 6% | 6% |
| Surfactant/Foaming | — | Emulgant | Emulgant | — | — |
| Agent | | (CO-55 ex | (CO-55 ex | | |
| | | SASOL) | SASOL) | | |
| | | 4% | 4% | | |
| | — | Sodium ether | Sodium ether | — | — |
| | | sulphate 1 | sulphate 1 | | |
| | | mole of | mole of | | |
| | | alcohols C12- | alcohols C12- | | |
| | | 14 | 14 | | |
| | | (Zetesol | (Zetesol AN70 | | |
| | | AN70 ex | ex Zschimmer | | |
| | | Zschimmer & | & Schwartz): | | |
| | | Schwartz): | 5% | | |
| | | 1% | | | |
| Appearance | Semi- | Transparent | Transparent | Transparent | Transparent Gel |
| | transparent | Gel | Gel | Gel | |
| | translucent Gel | | | | |
| Adhesiveness | Excellent | Gel disjoints | Gel disjoints | Good | Gel collapses as |
| | | within 8 | almost | | soon as applied |
| | | hours | immediately | | on the surface |
| Foaminess | Excellent | Low | Low | Medium/low | Not measurable |

The compositions according to the comparative examples 7 and 8, which use castor oil ethoxylate 40 moles as adhesion promoter, according to the disclosure of patent application MI2013A001545, once supplemented with LES (in various amounts) as foaming agent, lose their structural features in a quite fast manner. The composition of example 9, which use an ethoxylated tallow amine as adhesion promoter, has a good initial profile, but the gel so created tends to present a very slowly consumption and a satisfactory foam profile for the first flushing operations, but that tends to become unsatisfactory after 20-30 flushing operations. The composition according to example 10 using only LES as adhesion promoter, in absence of silica, collapses as soon as applied to the surface and thus adhesiveness and foaminess cannot be measured.

1. An adhesive detergent and/or perfuming composition, in the form of gel or a paste, directly applicable onto the surface of interest, adhering thereto without the aid of a support and/or container, and from which, if subjected to the action of water, is removed only after a great number of flushing operations, said composition being characterized in that it comprises
i) an adhesion promoter consisting of one or more salts of alkyl ether sulphates, preferably lauryl ether sulphate salts;
ii) silica;
iii) a perfuming agent;
iv) water.

2. The adhesive composition according to claim 1, wherein the adhesion promoter consists of one or more salts of alkyl ether sulphates, wherein the cation is a cation of organic or inorganic origin and the anion has formula
CH3(CH2)mCH2(OCH2CH2)nOSO3—
with m varying from 6 to 22, preferably from 8 to 16 and still more preferably is equal to 10 and n varying from 1 to 5, preferably is equal to 1 or 2.

3. The adhesive composition according to claim 1, wherein said cation of the alkyl ether sulphate salt is a cation of inorganic origin preferably selected from sodium, potassium, magnesium, ammonium, lithium, and more preferably is sodium or magnesium.

4. The adhesive composition according to claim 1, wherein said cation of the alkyl ether sulphate salt is a cation of organic origin, preferably having formula RR1R2NH+, wherein R, R1 and R2, independently from each other, are selected from hydrogen, ethyl, propyl, isopropyl, butyl, isobutyl, hydroxyethyl, hydroxypropyl, hydroxybutyl, hydroxyisopropyl provided that at least one of the groups R, R1 and R2 is different from a hydrogen atom and, more preferably, one of the substituents R, R1 and R2 is equal to hydroxyisopropyl and the remaining two are a hydrogen atom.

5. The adhesive composition in form of a gel according to claim 1, wherein the adhesion promoter is present in amount ranging from 20 to 60% by weight, preferably ranging from 30 to 50% and still more preferably is equal to 45% by weight, with respect to the total weight of the adhesive composition.

6. The adhesive Adhesive composition in form of a paste according to claim 1, wherein the adhesion promoter is present in amount ranging from 35 to 70% by weight, preferably ranging from 35 to 55% and still more preferably is equal to 45% by weight, with respect to the total weight of the adhesive composition.

7. The adhesive composition according to claim 1, wherein the silica component ii) is amorphous or crystalline and, preferably, is a synthetic, amorphous and precipitated silica.

8. The adhesive composition according to claim 1, wherein silica presents an average particle size lower than 500 micron, preferably lower than 100 micron and still more preferably has a particle size comprised between 8 and 13 micron, with an average value equal to 10 micron.

9. The adhesive composition in form of a gel according to claim 1, wherein silica is present in amount ranging from 0.1 to 20% by weight, preferably ranging from 0.5 to 10% by weight and still more preferably is equal to 8% by weight, with respect to the total weight of the adhesive composition.

10. The adhesive composition in form of a paste according to claim 1, wherein silica is present in amount ranging from 15 to 40% by weight, preferably ranging from 20 to 35% by weight and still more preferably is equal to 25% by weight, with respect to the total weight of the adhesive composition.

11. The adhesive composition according to claim 1, wherein the perfuming agent is present in amount ranging from 0.1 to 7% by weight, preferably ranging from 2 to 4% by weight and still more preferably is equal to 3% by weight, with respect to the total weight of the adhesive composition.

12. The adhesive composition in form of a gel according to claim 1, wherein water is present in amount ranging from 20 to 70% by weight, preferably from 35 to 60% by weight, with respect to the total weight of the adhesive composition.

13. The adhesive composition in form of a gel according to claim 1, wherein the adhesion promoter/water weight ratio ranges from 25:75 to 60:40, preferably equal to 50.56:49.44.

14. The adhesive omposition in form of a paste according to claim 1, wherein water is present in amount ranging from 10 to 30% by weight, preferably from 15 to 25% by weight, still more preferably equal to 23% by weight, with respect to the total weight of the adhesive composition.

15. The adhesive composition in form of a paste according to claim 1, wherein the adhesion promoter/silica weight ratio ranges from 75:25 to 56:44, preferably equal to 66:34.

16. The adhesive composition in form of a paste according to claim 1, further comprising an inert agent or inorganic filler selected among sulphates, chlorides or carbonates of sodium, magnesium, potassium, ammonium or calcium, soluble or insoluble, in an amount ranging of from 0.1 to 30% by weight, preferably of from 0.1 to 10% by weight and still more preferably equal to 5% by weight, with respect to the total weight of the adhesive composition, and a stabilizing agent selected among hydrolysed proteins, urea, hydroxyethylurea and alkyl lactate in an amount ranging of from 0.1 to 10% by weight, preferably of from 0.1 to 5% by weight and still more preferably equal to 0.6% by weight, with respect to the total weight of the adhesive composition.

17. The adhesive composition in form of a gel according to claim 1, having the following composition:
i) sodium and/or magnesium lauryl ether sulphate (SLES) or isopropanolammonium lauryl ether sulphate, wherein n is equal to 2, in amount equal to 45% by weight;
ii) silica in amount equal to 8% by weight;
iii) a perfuming agent in amount equal to 3% by weight;
iv) water in amount equal to 44% by weight.

18. The adhesive composition in form of a paste according to claim 1, having the following composition:
i) sodium and/or magnesium lauryl ether sulphate (SLES) or isopropanolammonium lauryl ether sulphate, wherein n is equal to 1, in amount equal to 45% by weight;
ii) silica in amount equal to 25% by weight;
iii) a perfuming agent in amount equal to 3% by weight;
iv) water in amount equal to 23% by weight;
v) an inorganic filler, preferably magnesium sulphate heptahydrate, in an amount equal to 5% by weight;
vi) a stabilizing agent, preferably hydrolysed wheat proteins, in an amount equal to 0.6% by weight.

19. The adhesive composition according to claim 1, comprising also agents having a biological action and/or of biological origin, such as bacteria, spores, enzymes, yeasts and mildews; colorants and/or preservatives and/or disinfecting agents, and/or agents useful to improve the consumption of the adhesive composition.

20. Use of the adhesive composition according to claim 1, as detergent and/or perfuming agent, through direct application onto the surface of interest of sanitary objects, household appliances, etc.
